(19) United States
(12) Patent Application Publication
(10) Pub. No.: US 2026/0064155 A1
(43) Pub. Date: Mar. 5, 2026

(54) EXTENSION DEVICE FOR ELECTRONIC DEVICE

(71) Applicant: Chicony Electronics Co., Ltd., New Taipei City (TW)

(72) Inventors: Shih Hao LU, New Taipei City (TW); Dong Lun YANG, New Taipei City (TW)

(21) Appl. No.: 19/248,504

(22) Filed: Jun. 25, 2025

Related U.S. Application Data
(60) Provisional application No. 63/687,786, filed on Aug. 28, 2024.

(30) Foreign Application Priority Data
Jan. 24, 2025 (TW) 114103640

(51) Int. Cl. G06F 1/16; G06F 1/26

(52) U.S. Cl. CPC G06F 1/1632; G06F 1/266

(57) ABSTRACT

The disclosure provides an extension device applicable to an electronic device. The extension device includes multiple connection ports, an USB hub, a multiplexer and a power control circuit. The connection ports include a first connection port, a second connection port and at least one third connection port. The USB hub is coupled to the second connection port and the at least one third connection port. The multiplexer is coupled to the first connection port, the second connection port and the USB hub. The power control circuit is coupled to the connection ports, the multiplexer and the USB hub, and is configured to selectively turn on the USB hub according to a state of the second connection port and a state of the at least one third connection port when the first connection port is in an operating state.

### CROSS-REFERENCE TO RELATED APPLICATION

This application claims priority to U.S. Provisional Application Ser. No. 63/687,786, filed on Aug. 28, 2024, and to Taiwan Application Serial Number 114103640, filed on Jan. 24, 2025, which is herein incorporated by reference in its entirety.

### BACKGROUND

### Field of Invention

This disclosure relates to an extension device, in particular to an extension device applicable to an electronic device.

### Description of Related Art

Generally speaking, some commercial universal serial bus (USB) hubs will continuously consume the electric power of the user device as long as they are connected to the user device, such as a smartphone, a tablet, a laptop, etc., such that the standby time of the user device is significantly reduced. Therefore, it is necessary to solve the above problems.

### SUMMARY

An aspect of disclosure relates to an extension device. The extension device is applicable to an electronic device, wherein the electronic device is configured to be coupled to an input device and/or at least one external device through the extension device. The extension device includes a plurality of connection ports, an USB hub, a multiplexer and a power control circuit. The plurality of connection ports include a first connection port, a second connection port and at least one third connection port. The USB hub is coupled to the second connection port and the at least one third connection port. The multiplexer is coupled to the first connection port, the second connection port and the USB hub. The power control circuit is coupled to the plurality of connection ports, the multiplexer and the USB hub, and is configured to selectively turn on the USB hub according to a state of the second connection port and a state of the at least one third connection port when the first connection port is in an operating state.

Another aspect of disclosure relates to an extension device. The extension device is applicable to an electronic device, wherein the electronic device is configured to be coupled to at least one external device through the extension device. The extension device includes a plurality of connection ports, an USB hub, a multiplexer, an input device and a power control circuit. The plurality of connection ports include a first connection port, a second connection port and at least one third connection port. The USB hub is coupled to the second connection port and the at least one third connection port. The multiplexer is coupled to the first connection port, the second connection port and the USB hub. The input device is electrically connected to the second connection port. The power control circuit is coupled to the plurality of connection ports, the multiplexer and the USB hub, and is configured to selectively turn on the USB hub according to a state of the at least one third connection port when the first connection port is in an operating state.

### BRIEF DESCRIPTION OF THE DRAWINGS

The disclosure can be more fully understood by reading the following detailed description of the embodiment, with reference made to the accompanying drawings as follows:

FIG. 1 is a circuit block diagram of an extension device in accordance with some embodiments of the disclosure;

FIG. 2A is a schematic diagram of a scenario of the extension device in accordance with some embodiments of the disclosure;

FIG. 2B is a schematic diagram of a scenario of the extension device in accordance with some embodiments of the disclosure;

FIG. 2C is a schematic diagram of a scenario of the extension device in accordance with some embodiments of the disclosure; and

FIG. 3 is a circuit block diagram of an extension device in accordance with some embodiments of the disclosure.

### DETAILED DESCRIPTION

The embodiments are described in detail below with reference to the appended drawings to better understand the aspects of the disclosure. However, the provided embodiments are not intended to limit the scope of the disclosure, and the description of the structural operation is not intended to limit the order in which they are performed. Any device that has been recombined by components and produces an equivalent function is within the scope covered by the disclosure.

The terms used in the entire specification and the scope of the patent application, unless otherwise specified, generally have the ordinary meaning of each term used in the field, the content disclosed herein, and the particular content.

The terms “coupled” or “connected” as used herein may mean that two or more elements are directly in physical or electrical contact, or are indirectly in physical or electrical contact with each other. It can also mean that two or more elements interact with each other.

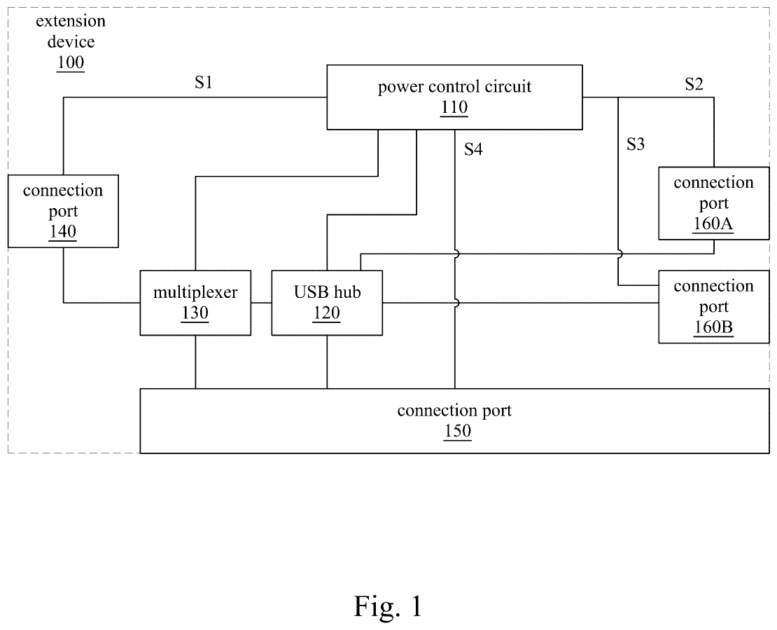

Referring to FIG. 1, FIG. 1 is a circuit block diagram of an extension device 100 in accordance with some embodiments of the disclosure. In some embodiments, as shown in FIG. 1, the extension device 100 includes a power control circuit 110, an USB hub 120, a multiplexer 130, a connection port 140, a connection port 150 and multiple connection ports 160A and 160B.

In some embodiments, the connection port 140 is implemented by an USB-C plug. Accordingly, the extension device 100 can be electrically connected to any device having an USB-C socket (e.g., a mobile device operable by a user, such as a smartphone, a tablet, a laptop, etc.) through the connection port 140, and can extend any accessary or equipment (e.g., an external device, such as a display, a speaker, a mouse, a keyboard, etc.) to said any device through the connection port 150 and the connection ports 160A and 160B, to meet any requirement of the user of said any device. In addition, the connection port 150 is implemented by an USB-A socket, the connection port 160A is implemented by an USB-C socket, and the connection port 160B is implemented by an USB-A socket. However, the disclosure is not limited herein. For example, in some embodiments, each of the connection port 140, the connection port 150 and the connection ports 160A and 160B can be any type of plug or socket, such as USB-A, USB-C, pogo pin, Lighting, etc.

As shown in FIG. 1, the power control circuit 110 is coupled to the USB hub 120, the multiplexer 130, the connection port 140, the connection port 150 and the connection ports 160A and 160B. The multiplexer 130 is coupled to the connection port 140, the connection port 150 and the USB hub 120. The USB hub 120 is coupled to the connection port 150 and the connection ports 160A and 160B.

In some embodiments, the power control circuit 110 is configured to receive multiple state signals S1-S4 from the connection port 140, the connection port 150 and the connection ports 160A and 160B. Each of the state signals S1-S4 is configured to indicate that a corresponding one of the connection port 140, the connection port 150 and the connection ports 160A and 160B is in an operating state or a non-operating state. The connection port 140 and the mobile device are taken as an example herein. If the connection port 140 is in the operating state, it means the connection port 140 is electrically connected to the mobile device. If the connection port 140 is in the non-operating state, it means the connection port 140 is not electrically connected to the mobile device.

In accordance with the above descriptions, the power control circuit 110 can obtain the states of the connection port 140, the connection port 150 and the connection ports 160A and 160B through the state signals S1-S4, and can control the multiplexer 130 and the USB hub 120 accordingly, so as to achieve multiple functions, such as an electric power management, a data transmission, etc.

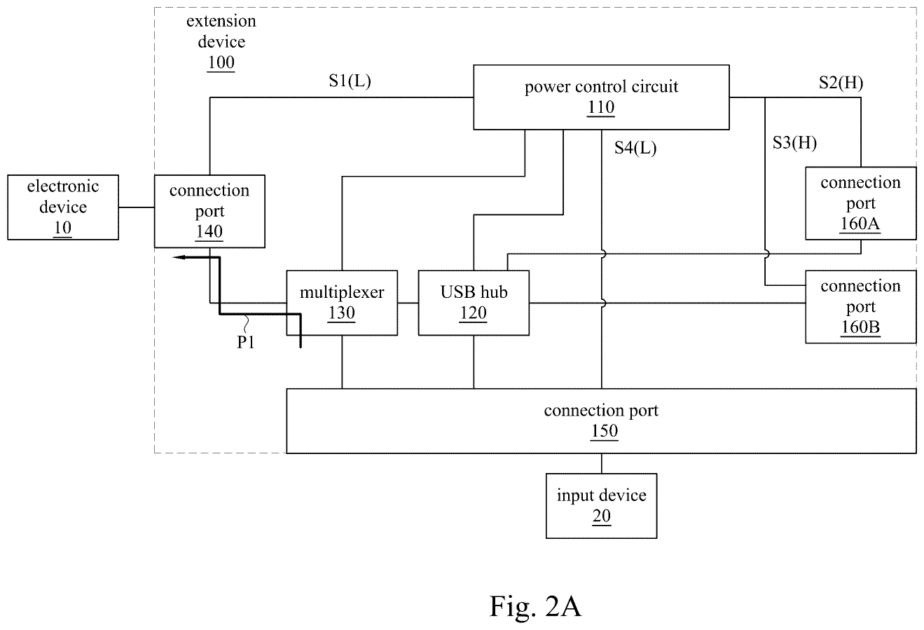

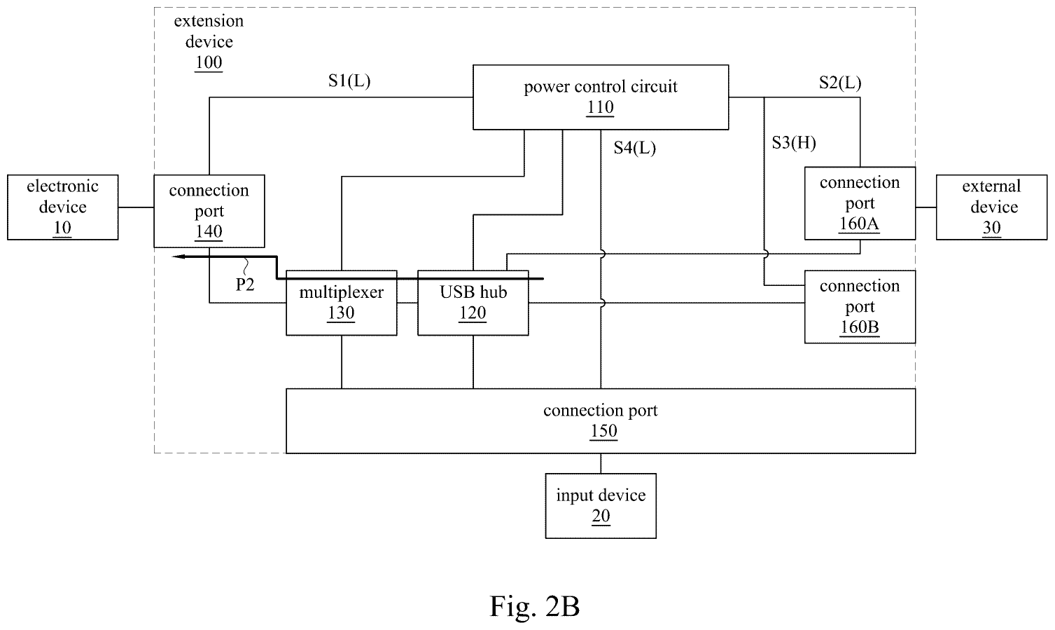

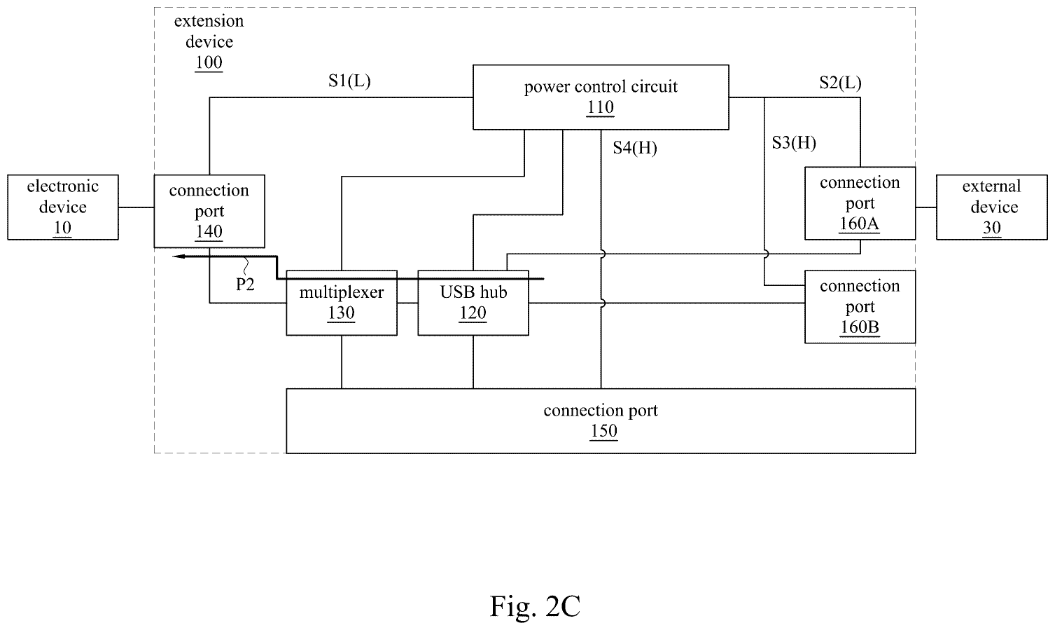

The operations of the extension device 100 will be described in detail below with reference to FIGS. 2A-2C. FIGS. 2A-2C are schematic diagrams of multiple scenarios of the extension device 100, respectively, in accordance with some embodiments of the disclosure. In the embodiments of FIGS. 2A-2C, the connection port 140 is implemented by an USB-C plug, the connection port 150 is implemented by a pogo pin, and the connection ports 160A and 160B each is implemented by an USB-C socket. In some embodiments, the connection port 150 can also be implemented by a different type of socket, such as USB-A, USB-C, etc., which is not limited herein.

In some embodiments, as shown in FIG. 2A, the extension device 100 is electrically connected to an electronic device 10 through the connection port 140, and is electrically connected to an input device 20 through the connection port 150. In particular, the electronic device 10 can be implemented by a tablet, and the input device 20 can be implemented by a keyboard. Also, the connection ports 160A and 160B are not connected to the exterior devices.

Under the scenario of FIG. 2A, the connection port 140 generates the state signal S1 having a logic level L, the connection port 150 generates the state signal S4 having the logic level L, and the connection ports 160A and 160B generate the state signals S2 having a logic level H and the state signals S3 having the logic level H, respectively. In particular, the logic level L can correspond to the lowest voltage level (e.g., a ground voltage) reachable by setting the extension device 100, and is used to the corresponding connection port 140 or connection port 150 being connected or in the operating state. The logic level H can correspond to the highest voltage level (e.g., a power voltage) reachable by setting the extension device 100, and is used to the corresponding connection port 160A or connection port 160B being disconnected or in the non-operating state. However, the disclosure is not limited herein. In some embodiments, the logic level H can the corresponding connection port being connected or in the operating state, and the logic level L can the corresponding connection port being disconnected or in the non-operating state.

In accordance with the above descriptions, below descriptions are further made by taking the connection port 140 and the connection 160A, respectively, implemented by the USB-C plug and the USB-C socket. The connection port 140 and the connection 160A can generate the state signal S1 and the state signal S2, respectively, through their configuration channel pins. For example, when the configuration channel pin of the connection port 140 contacts a conducting terminal of the electronic device 10, the configuration channel pin of the connection port 140 generates the state signal S1 having the logic level L. In another example, when the configuration channel pin of the connection port 160A contacts no conducting terminal, the configuration channel pin of the connection port 160A generates the state signal S2 having the logic level H. It should be understood that the connection port 150 and the connection port 160B can also generate the state signal S4 and the state signal S3, respectively, through their specific pins.

Under the scenario of FIG. 2A, the power control circuit 110, by receiving the state signals S1-S4, obtains the connection port 140 and the connection port 150 being in the operating state, and obtains the connection port 160A and the connection port 160B being in the non-operating state. Accordingly, the power control circuit 110 stops delivering the electric power to the USB hub 120. At the same time, since the USB hub 120 is not powered and unable to work, the multiplexer 130 is further controlled by the power control circuit 110 to enable a signal path P1 between the connection port 140 and the connection port 150. From the above descriptions, it can be seen that the power control circuit 110 can control the electric power to be delivered to the USB hub 120 according the logic levels of the state signals S1-S4, so the USB hub 120 is in a turn-on or turn-off state. Thus, the consumption of the electric power provided to the extension device 100 by the electronic device 10 can be saved, and the USB hub 120 is prevented from continuously being in the turn-on state, which can achieve the energy-saving effects, such as reducing the bulk temperature of the extension device 100, the power consumption and/or heat production of the extension device 100, etc.

It should be understood that, in the above embodiments, the premise of the extension device 100 to work is the electronic device 10 being electrically connected to the extension device 100. If only the input device 20 is electrically connected to the extension device 100, the extension device 100 will not work because not having the power source (i.e., the electronic device 10). That is to say, when the extension device 100 is electrically connected to the electronic device 10, the electronic device 10 provides the electric power required by the extension device 100 through the connection port 140.

From the descriptions of FIG. 2A, it can be seen that, in some embodiments, when the connection port 140 is in the operating state, the power control circuit 110, in response to the connection port 150 being in the operating state and the connection ports 160A and 160B being in the non-operating state, turns off the USB hub 120, and controls the multiplexer 130 to switch to turning on the signal path P1 between the connection port 140 and the connection port 150 by, for example transmitting a switch signal (not shown) to the multiplexer 130. In particular, the signal path P1 will not conduct the connection port 140 and the USB hub 120, that is, the connection port 140 and the USB hub 120 are not electrically connected to each other through the multiplexer 130. Therefore, the electronic device 10 and the input device 20 can transmit data to each other without using the USB hub 120.

In some embodiments, as shown in FIG. 2B, the extension device 100 is electrically connected to the electronic device 10 through the connection port 140, is electrically connected to the input device 20 through the connection port 150, and is electrically connected to an external device 30 through the connection port 160A. In particular, the electronic device 10 can be implemented by a tablet, the input device 20 can be implemented by a keyboard, and the external device 30 can be implemented by an USB device having an USB-C plug or capable of connecting an USB-C socket through an USB-C cable. That is to say, in the embodiments of FIG. 2B, only the connection port 160B is not connected to an exterior device.

Under the scenario of FIG. 2B, the connection port 140 generates the state signal S1 having the logic level L, the connection port 150 generates the state signal S4 having the logic level L, the connection port 160A generates the state signal S2 having the logic level L, and the connection port 160B generates the state signals S3 having the logic level H. The power control circuit 110, by receiving the state signals S1-S4, obtains the connection port 160B being only in the non-operating state. Accordingly, the power control circuit 110 delivers the electric power to the USB hub 120. At the same time, since the USB hub 120 is able to work, the multiplexer 130 is further controlled by the power control circuit 110 to enable a signal path P2 between the connection port 140 and the USB hub 120.

From the descriptions of FIG. 2B, it can be seen that, in some embodiments, when the connection port 140 is in the operating state, the power control circuit 110, in response to the connection port 150 being in the operating state and at least one of the connection ports 160A and 160B (i.e., the connection port 160A) being in the operating state, turns on the USB hub 120, and controls the multiplexer 130 to switch to turning on the signal path P2 between the connection port 140 and the USB hub 120. Therefore, the electronic device 10 and the input device 20 can transmit data to each other through both the multiplexer 130 and the USB hub 120 (i.e., through the signal path P2). In addition, the external device 30 also transmits data to the electronic device 10 through both the multiplexer 130 and the USB hub 120 (i.e., through the signal path P2).

In some embodiments, as shown in FIG. 2C, the extension device 100 is electrically connected to the electronic device 10 through the connection port 140, and is electrically connected to the external device 30 through the connection port 160A. In particular, the electronic device 10 can be implemented by a tablet, and the external device 30 can be implemented by an USB device having an USB-C plug or capable of connecting an USB-C socket through an USB-C cable.

Under the scenario of FIG. 2C, the connection port 140 generates the state signal S1 having the logic level L, the connection port 150 generates the state signal S4 having the logic level H, the connection port 160A generates the state signal S2 having the logic level L, and the connection port 160B generates the state signals S3 having the logic level H. The power control circuit 110, by receiving the state signals S1-S4, obtains the connection port 140 and the connection port 160A being in the operating state, and obtains the connection port 150 and connection port 160B being in the non-operating state. Accordingly, the power control circuit 110 delivers the electric power to the USB hub 120. At the same time, since the USB hub 120 is able to work, the multiplexer 130 is further controlled by the power control circuit 110 to enable the signal path P2 between the connection port 140 and the USB hub 120.

From the descriptions of FIG. 20, it can be seen that, in some embodiments, when the connection port 140 is in the operating state, the power control circuit 110, in response to at least one of the connection ports 160A and 160B (i.e., the connection port 160A) being in the operating state, turns on the USB hub 120, and controls the multiplexer 130 to switch to turning on the signal path P2 between the connection port 140 and the USB hub 120. Therefore, the electronic device 10 and the external device 30 can transmit data to each other through both the multiplexer 130 and the USB hub 120.

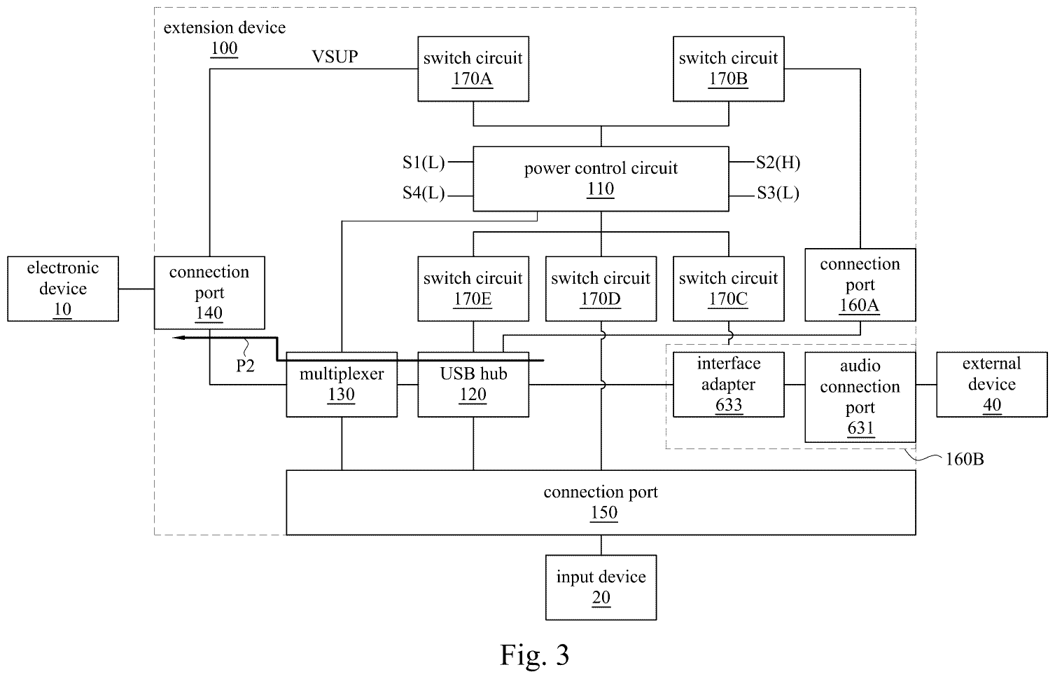

In the above embodiments, the power control circuit 110 can be implemented by an USB power delivery IC, and is configured to perform an electric power distribution, which would be described below with reference to FIG. 3. FIG. 3 is a circuit block diagram of the extension device 100 in accordance with some embodiments of the disclosure. In comparison to the embodiments of FIG. 1, the extension device 100 further includes multiple switch circuits 170A-170E in the embodiments of FIG. 3.

The switch circuit 170A is coupled between the connection port 140 and the power control circuit 110. The switch circuit 170B is coupled between the connection port 160A and the power control circuit 110. The switch circuit 170C is coupled between the connection port 160B and the power control circuit 110. The switch circuit 170D is coupled between the connection port 150 and the power control circuit 110. The switch circuit 170E is coupled between the USB hub 120 and the power control circuit 110. In brief, each of the switch circuits 170A-170E is coupled between the power control circuit 110 and a corresponding one of the connection port 140, the connection port 150, the connection ports 160A and 160B and the USB hub 120. In particular, each of the switch circuits 170A-170E can be implemented by a metal oxide semiconductor field effect transistor (MOSFET), but the disclosure is not limited herein.

In addition, the connection port 160B of FIG. 3 includes an audio connection port 631 and an interface adapter 633, and the interface adapter 633 is coupled between the audio connection port 631 and the USB hub 120. In particular, the audio connection port 631 can be implemented by an audio jack, and the interface adapter 633 can be implemented by an USB audio codec.

In some embodiments, the power control circuit 110 is configured to control the switch circuits 170A-170E according to the state of the connection port 140, the state of the connection port 150 and the states of the connection ports 160A and 160B, to perform the electric power distribution, which would be described in the following paragraphs by taking a scenario of FIG. 3 as an example.

As shown in FIG. 3, the extension device 100 is electrically connected to the electronic device 10 through the connection port 140, is electrically connected to the input device 20 through the connection port 150, and is electrically connected to an external device 40 through the connection port 160B. In particular, the electronic device 10 can be implemented by a tablet, the input device 20 can be implemented by a keyboard, and the external device 40 can be implemented by any audio device having an audio connector or capable of connecting an audio socket through an audio cable.

Under the scenario of FIG. 3, the connection port 140 generates the state signal S1 having the logic level L, the connection port 150 generates the state signal S4 having the logic level L, the connection port 160A generates the state signal S2 having the logic level H, and the connection port 160B generates the state signals S3 having the logic level L. The power control circuit 110, by receiving the state signals S1-S4, obtains the connection port 140, the connection port 150 and the connection port 160B being in the operating state, and obtains the connection port 160A being in the non-operating state.

Accordingly, the power control circuit 110 controls the switch circuit 170A, the switch circuit 170C, the switch circuit 170D and the switch circuit 170E to be in the turn-on state, and controls the switch circuit 170B to be in the turn-off state. In such arrangements, the power control circuit 110 can receive a supply voltage VSUP from the electronic device 10 through the switch circuit 170A. The power control circuit 110 can provide the supply voltage VSUP or a voltage converted from the supply voltage VSUP to the external device 40 through the switch circuit 170C and the connection port 160B. The power control circuit 110 can provide the supply voltage VSUP or a voltage converted from the supply voltage VSUP to the input device 20 through the switch circuit 170D and the connection port 150. Also, the power control circuit 110 can provide the supply voltage VSUP or a voltage converted from the supply voltage VSUP to the USB hub 120 through the switch circuit 170E.

In addition, in the embodiments of FIG. 3, since at least one of the connection port 150 and the connection ports 160A and 160B (i.e., the connection port 160B) is in the operating state, the power control circuit 110 controls the multiplexer 130 to turn on the signal path P2 between the connection port 140 and the USB hub 120. Therefore, the electronic device 10 and the input device 20 can transmit data to each other through the multiplexer 130 and the USB hub 120, and the electronic device 10 and the external device 40 can transmit data to each other through the multiplexer 130 and the USB hub 120.

From the descriptions of FIG. 3, it can be seen that, in some embodiments, the extension device 100 further includes a power converter, such as a DC-DC converter (e.g., a buck converter, a boost converter, etc.). The power converter can be coupled to the power control circuit 110, and is configured to convert, for example the supply voltage VSUP, to provide suitable voltages to the external device 40, the input device 20 and the USB hub 120.

In the above embodiments, the state of the connection port 140, the state of the connection port 150 and the states of the connection ports 160A and 160B are detected by the power control circuit 110, but the disclosure is not limited herein. For example, the function of detecting the state of the connection port 140, the state of the connection port 150 and the states of the connection ports 160A and 160B can be independent from the power control circuit 110, and be executed by a detection circuit (not shown). The detection circuit can be coupled to the connection port 140, the connection port 150, the connection ports 160A and 160B and the power control circuit 110, and can receive the state signals S1-S4, to generate and transmit a detection result to the power control circuit 110. In such arrangements, the power control circuit 110 can also obtain the state of the connection port 140, the state of the connection port 150 and the states of the connection ports 160A and 160B from the detection result. In some further embodiments, the detection circuit can further perform an overcurrent detection and/or overvoltage detection, to achieve an overcurrent protection and/or overvoltage protection.

In some embodiments, the external device 30 of FIGS. 2B and 2C can be implemented by a power adaptor. When the external device 30 is electrically connected to the connection port 160A, the power control circuit 110 can receive a power supply voltage (not shown) from the external device 30 through the connection port 160A, and can charge the electronic device 10 by the power supply voltage or a voltage converted from the power supply voltage. That is to say, the extension device 100 also has a function of receiving the electric power provided by the external device 30 and delivering the electric power to the electronic device 10 for charging the electronic device 10.

From the embodiments of FIGS. 1, 2A-2C and 3, the extension device 100 of the disclosure is mainly used to meet the user's requirements on extending the electronic device 10. When the connection port 140 is in the operating state (i.e., when the electronic device 10 is electrically connected to the connection port 140), the power control circuit 110 selectively turn on the USB hub 120 according to the state of the connection port 150 and the states of the connection ports 160A and 160B. In such way, the extension device 100 of the disclosure can prevent the problems of the user device's electric power being continuously consumed as long as the USB hub is connected to the user device in the related arts, thereby having the advantages of reducing the power consumption of the electronic device 10, saving energy, being connected to the electronic device 10 for a long time, not affecting the standby time of the electronic device 10, etc.

In addition, from the descriptions of the above embodiments, it can be seen that when the connection port 140 is in the operating state, the power control circuit 110 will turn off the USB hub 120 if only the connection port 150 is in the operating state. The reason for such arrangements is that the input device 20 and the extension device 100 are integrated together in some embodiments. In other words, the extension device 100 can further include the input device 20, and the input device 20 is constantly and electrically connected to the connection port 150 (i.e., the connection port 150 is constantly in the operating state). By such arrangements, when the connection port 140 is in the operating state, the power control circuit 110 only needs to selectively turn on the USB hub 120 according to the states of the connection ports 160A and 160B. Notably, when the connection port 140 is in the operating state, the power control circuit 110 will turn off the USB hub 120 if the connection ports 160A and 160B are both in the non-operating state, such that the extension device 100 including the input device 20 also has the advantages of reducing the power consumption of the electronic device 10, saving energy, being connected to the electronic device 10 for a long time, not affecting the standby time of the electronic device 10, etc.

Although the disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the disclosure without departing from the scope or spirit of the invention. In view of the foregoing, it is intended that the invention cover modifications and variations of this invention provided they fall within the scope of the following claims.

What is claimed is:

1. An extension device, applicable to an electronic device, wherein the electronic device is configured to be coupled to an input device and/or at least one external device through the extension device, and the extension device comprises:
a plurality of connection ports, comprising a first connection port, a second connection port and at least one third connection port;
an USB hub, coupled to the second connection port and the at least one third connection port;
a multiplexer, coupled to the first connection port, the second connection port and the USB hub; and
a power control circuit, coupled to the plurality of connection ports, the multiplexer and the USB hub, and configured to selectively turn on the USB hub according to a state of the second connection port and a state of the at least one third connection port when the first connection port is in an operating state.

2. The extension device of claim 1, wherein when the first connection port is in the operating state, the power control circuit, in response to the second connection port being in the operating state and the at least one third connection port being in a non-operating state, turns off the USB hub and controls the multiplexer to switch to turning on a signal path between the first connection port and the second connection port.

3. The extension device of claim 1, wherein when the first connection port is in the operating state, the power control circuit, in response to the second connection port being in the operating state and the at least one third connection port being in the operating state, turns on the USB hub and controls the multiplexer to switch to turning on a signal path between the first connection port and the USB hub.

4. The extension device of claim 1, wherein when the first connection port is in the operating state, the power control circuit, in response to the at least one third connection port being in the operating state, turns on the USB hub and controls the multiplexer to switch to turning on a signal path between the first connection port and the USB hub.

5. The extension device of claim 1, further comprising:
a plurality of switch circuits, wherein each of the plurality of switch circuits is coupled between the power control circuit and a corresponding one of the USB hub and the plurality of connection ports, and the power control circuit is configured to control the plurality of switch circuits according to a state of the first connection port, the state of the second connection port and the state of the at least one third connection port, to perform an electric power distribution.

6. The extension device of claim 5, wherein the power control circuit is configured to turn on or off the USB hub by turning on or off a corresponding one of the plurality of switch circuits.

7. The extension device of claim 1, wherein the first connection port is in the operating state when the first connection port is electrically connected to the electronic device.

8. The extension device of claim 1, wherein the input device is a keyboard, and the second connection port is in the operating state when the second connection port is electrically connected to the input device.

9. The extension device of claim 1, wherein the at least one external device is an USB device or a power converter, and the at least one third connection port is in the operating state when the at least one third connection port is electrically connected to the at least one external device.

10. The extension device of claim 1, wherein the at least one third connection port comprises an audio connection port and an interface adapter, the at least one external device is an audio device, and the at least one third connection port is in the operating state when the audio connection port is electrically connected to the audio device.

11. The extension device of claim 1, wherein the power control circuit is configured to receive a plurality of state signals from the plurality of connection ports, and to control an electric power to be delivered to the USB hub according to logic levels of the plurality of state signals, to turn on or off the USB hub,
wherein when one of the plurality of state signals has a first logic level, the power control circuit determines a corresponding one of the plurality of connection ports is in the operating state, and when the one of the plurality of state signals has a second logic level, the power control circuit determines the corresponding one of the plurality of connection ports is in a non-operating state.

12. The extension device of claim 1, further comprising:
a detection circuit, coupled to the plurality of connection ports and the power control circuit, configured to receive a plurality of state signals from the plurality of connection ports, to generate and transmit a detection result to the power control circuit, wherein the detection result includes each of the plurality of connection ports is in the operating state or a non-operating state.

13. An extension device, applicable to an electronic device, wherein the electronic device is configured to be coupled to at least one external device through the extension device, and the extension device comprises:
a plurality of connection ports, comprising a first connection port, a second connection port and at least one third connection port;
an USB hub, coupled to the second connection port and the at least one third connection port;
a multiplexer, coupled to the first connection port, the second connection port and the USB hub;
an input device, electrically connected to the second connection port; and
a power control circuit, coupled to the plurality of connection ports, the multiplexer and the USB hub, and configured to selectively turn on the USB hub according to a state of the at least one third connection port when the first connection port is in an operating state.

14. The extension device of claim 13, wherein when the first connection port is in the operating state, the power control circuit, in response to the at least one third connection port being in a non-operating state, turns off the USB hub and controls the multiplexer to switch to turning on a signal path between the first connection port and the second connection port.

15. The extension device of claim 13, wherein when the first connection port is in the operating state, the power control circuit, in response to the at least one third connection port being in the operating state, turns on the USB hub and controls the multiplexer to switch to turning on a signal path between the first connection port and the USB hub.

16. The extension device of claim 13, further comprising:
a plurality of switch circuits, wherein each of the plurality of switch circuits is coupled between the power control circuit and a corresponding one of the USB hub and the plurality of connection ports, and the power control circuit is configured to control the plurality of switch circuits according to a state of the first connection port, a state of the second connection port and the state of the at least one third connection port, to perform an electric power distribution.

17. The extension device of claim 16, wherein the power control circuit is configured to turn on or off the USB hub by turning on or off a corresponding one of the plurality of switch circuits.

18. The extension device of claim 13, wherein the first connection port is in the operating state when the first connection port is electrically connected to the electronic device.

19. The extension device of claim 13, wherein the input device is a keyboard, and the second connection port is in the operating state when the second connection port is electrically connected to the input device.

20. The extension device of claim 13, wherein the at least one external device is an USB device or a power converter, and the at least one third connection port is in the operating state when the at least one third connection port is electrically connected to the at least one external device.

21. The extension device of claim 13, wherein the at least one third connection port comprises an audio connection port and an interface adapter, the at least one external device is an audio device, and the at least one third connection port is in the operating state when the audio connection port is electrically connected to the audio device.

22. The extension device of claim 13, wherein the power control circuit is configured to receive a plurality of state signals from the plurality of connection ports, and to control an electric power to be delivered to the USB hub according to logic levels of the plurality of state signals, to turn on or off the USB hub,
wherein when one of the plurality of state signals has a first logic level, the power control circuit determines a corresponding one of the plurality of connection ports is in the operating state, and when the one of the plurality of state signals has a second logic level, the power control circuit determines the corresponding one of the plurality of connection ports is in a non-operating state.

23. The extension device of claim 13, further comprising:
a detection circuit, coupled to the plurality of connection ports and the power control circuit, configured to receive a plurality of state signals from the plurality of connection ports, to generate and transmit a detection result to the power control circuit, wherein the detection result includes each of the plurality of connection ports is in the operating state or a non-operating state.
